(19) United States
(12) Patent Application Publication
(10) Pub. No.: US 2005/0055765 A1
(43) Pub. Date: Mar. 17, 2005

(54) Non-rotatable joints for shower head

(76) Inventor: Roland Lagasse, South Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/662,935

(22) Filed: Sep. 15, 2003

(51) Int. Cl. A47K 3/00

(52) U.S. Cl. 4/615

(57) ABSTRACT

A shower assembly is mounted by a plurality of links which move pivotally relative to each other. The pivot joints include an end wall and cup on one of the two members, and a hollow cylindrical connection on the other. Water must pass through the two links to the showerhead. Appropriate porting and flow passages are formed through the links, and through the portions of the links which are secured at the pivot joint. The end wall includes a fixed threaded member extending outwardly from the end wall and beyond the cup. A nut is tightened on the threaded member, to tighten the cylindrical hollow portion against the cup, to secure the joint. Since the threaded member is fixed to the end wall, the threaded member will not move relative to the two linkages as has been the case in the prior art.

### BACKGROUND OF THE INVENTION

This invention relates to a joint for a shower arm arrangement wherein several links may pivot relative to each other, but wherein the pivot joints are less likely to rotate compared to the prior art.

Showers are often mounted on a plurality of links in the prior art. The links allow adjustment of the position of the showerhead, such as for varying heights of individuals. The links have historically been such that they have pivot joints interconnecting them, allowing pivoting of the links to move the showerhead vertically upwardly and downwardly, and horizontally toward and away from a wall. Typically, the last joint further allows the showerhead to pivot around a central axis of the showerhead.

Recently, enlarged showerheads have become more popular. These are relatively large area showerheads for delivering a flow of water over a larger area.

With the known pivot joints for showerheads, and particularly when the known joints are applied to the enlarged heads, there has sometimes been movement within the joints, allowing the links to move against the wishes of the user. As an example, each joint is typically provided with a bolt or other threaded member extending through both of the links which are being pivotally interconnected. A nut is attached on the opposed end of the bolt to hold the two links together. The user then adjusts the links to move the showerhead to its desired position, and tightens the nut. However, in practice, the bolts have sometimes turned, and have loosened the connection. This may sometimes allow the link to move, which is undesirable. Further, as the joint loosens, such as by movement of the bolt, leakage of the water passing through the linkages to the showerhead has sometimes occurred around the bolt.

Moreover, in general, the links have met in a face-to-face surface contact which has also not provided the most secure connection.

Obviously, it would be desirable to have a more reliable joint.

### SUMMARY OF THE INVENTION

In a disclosed embodiment of this invention, two links are pivotally connected together to mount a showerhead. The links also allow flow of water through passages formed in each of the links such that water can flow from a source of water to the showerhead. The pivot joint is more reliable than in the prior art since a bolt is fixed to one of the links. Thus, in a preferred embodiment, one of the links has a generally cupped shaped end wall and an open end of the cup. The bolt is fixed to the end wall and extends from the end wall and beyond the open end. The other link includes a generally circular connection portion which is brought onto the threaded member, and into abutting contact with the opposed cup. A seal of some sort is placed between the circular connection portion of the second link, and the end of the cup of the first link. A wing nut, or other nut is then secured beyond the second link, and onto the threaded member. The wing nut is tightened to lock the two links together. Here again, it is preferable that a seal is placed between the end link and the wing nut. Also, decorative members may also be utilized in this connection.

Preferably, the open end of the cup and the generally circular connection portion of the other link are such that the two have a ledge and supporting boss structure which can be closely machined to provide a tight fit. This along resists relative movement between the two links, such that the connection is less likely to rotate or loosen.

The present invention preferably is utilized in a system including at least three links, with two of the above-mentioned types of pivot joints being utilized.

With this invention, there is no likelihood of the threaded member rotating relative to the two links. Instead, the threaded member is fixed to one of the links and cannot rotate relative to the two links. Also, the boss support allows close machining, and hence a more reliable joint. In this manner, the present invention improves upon the prior art. These and other features of the present invention can be best understood from the following specification and drawings, the following of which is a brief description.

### BRIEF DESCRIPTION OF THE DRAWINGS

FIG. 1 is a schematic view of the showerhead assembly of the present invention.

FIG. 2 is an exploded view of the components of one joint.

FIG. 3 is a cross-sectional view through two pivot connections according to the prior art.

### DETAILED DESCRIPTION OF A PREFERRED EMBODIMENT

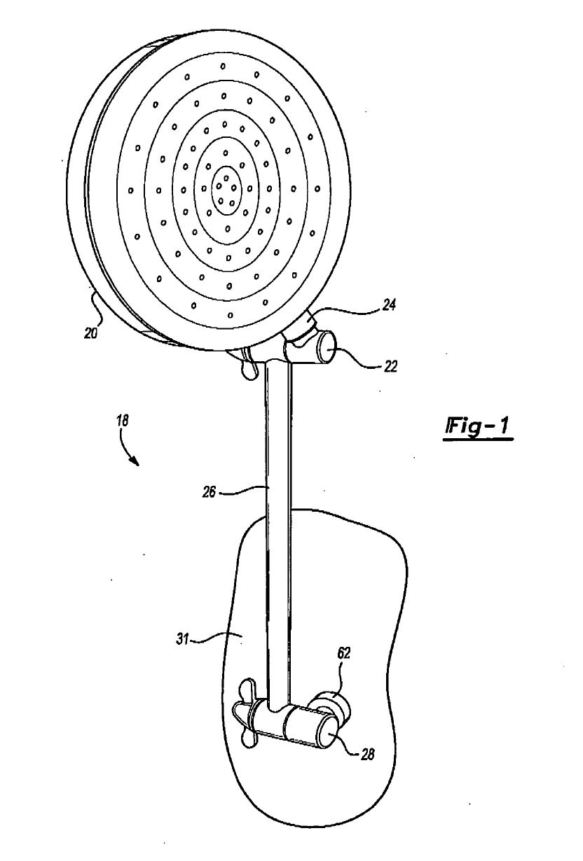

A shower mount arrangement 18 is illustrated in FIG. 1 mounting an enlarged head shower 20. Notably, the enlarged head 20 is connected to a smaller pipe or link 24. For purposes of this application, an enlarged head shower is perhaps best understood to be the type of shower, such as illustrated, wherein there is a relatively small diameter link 24 leading outwardly to a generally planar enlarged head 20. In contrast, typical showerheads are flared slightly outwardly along their length to the outlet portion of the showerhead. While the present invention is preferably utilized on enlarged showerheads, it would also have application in smaller showerheads.

As shown, there is a link 26 connecting the link 24 to a wall 31, shown schematically. Pivot connections 22 and 28 connect the links 24, 26 and wall 31.

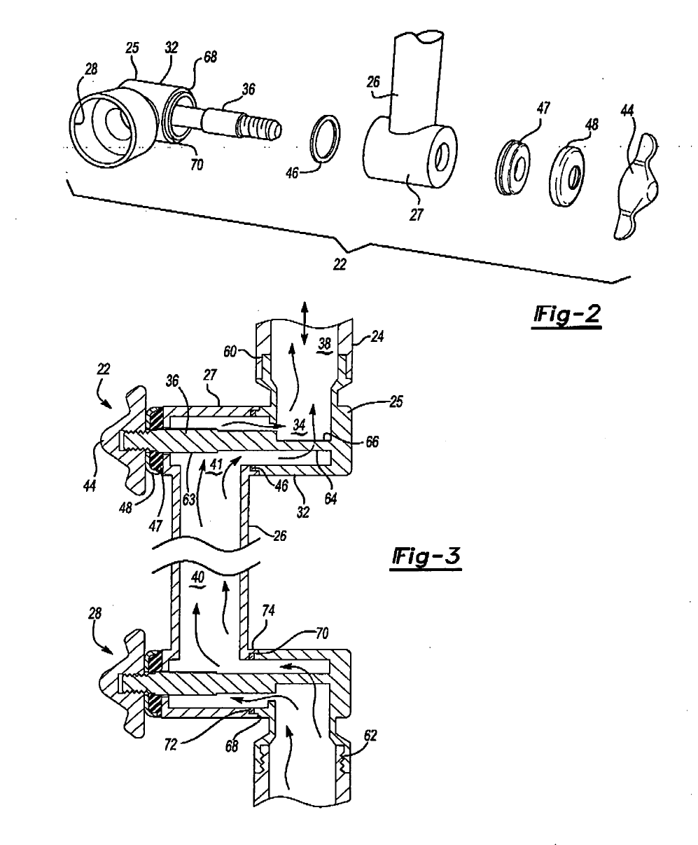

FIG. 2 is an exploded view of one pivot connection, and FIG. 3 is a cross-sectional view through connections 22 and 28. As shown, the link 24 leads to a cup portion 25 which receives the link 26. The link 26 has a generally hollow cylindrical portion 27 which provides its portion of the pivot joint. The end wall 25 includes a cup portion 32 extending forwardly, and defining the fluid chamber 34 surrounding a threaded central member 36. A threaded central member 36 is formed to be fixed with the end wall 25. Member 36 could be attached, or formed with the wall 25. However, for purposes of this invention, what is most important is that the threaded member 36 remains fixed relative to the cup 25. As shown, a fluid passage 38 leads outwardly through the cup 32 to communicate water through a connection 28 into the showerhead 20. Thus, water from the chamber 34 leads into opening 38, and outwardly through the showerhead 20. A passage 40 extends through the link 26, and through a similar passage 41 to supply water to the passage 34.

As is also clear from FIG. 3, each of the pivot connections 22 and 28 have a guiding boss portion provided by one of the two links. In the illustrated embodiment, the cup 32 includes a boss portion 68 and an end ledge 70. The cylindrical portion 27 includes its own cylindrical extending boss 74 which is received abutting the ledge 70 and about the boss 68. A similar ledge 72 is formed on the cylindrical portion 27, and sandwiches the seal 46 between the two members. This portion of the pivot connections 22 and 28 are identical. The inner diameter of the boss 74 and the outer diameter of the boss 68 can be closely machined to very tight tolerances. This ensures that there is resistance to relative movement between the links once the nuts are tightened. Thus, this guiding boss-like mount structure ensures the links are less likely to rotate at the pivot joints.

As shown, a wing nut 44 is secured onto the threaded member 36 to lock the link 26 and the link 24 together. As shown, a seal 46 may be placed between the cylindrical portion 27 and the end cup 32. A seal 47, and decorative member 48 is placed between the wing nut 44 and the hollow cylindrical portion 42.

The two pivot connections are generally identical, as mentioned above. One distinction is that between the link 24 which is connected directly to the showerhead 20, and the fluid connection 28, there is a sliding connection 60. This connection allows the link 28 to rotate 360° about a central axis X. This allows the showerhead to pivot to a desired angle. The connection between the link 26 and the fixed mount member 62 does not allow similar movement. The fixed mount member 62 is identified as a third link for purposes of this application. As is clear from FIG. 3 also, the threaded member 36 does not have a uniform outer diameter. Instead, the threaded member 36 has an enlarged outer diameter portion 63, then a somewhat smaller diameter portion 64, and an even smaller diameter portion 66 adjacent the passage 38. In this way, the flow of water between the passage 41 and the connection 38 is not unduly restricted. Since the threaded member 36 is fixed to the cup 25, the desired angular position of the smaller portion 66 relative to the flow passages such as passage 38 can be as desired. If the threaded member 36 could rotate, then of course the smaller portion 66 could become misaligned.

The present invention thus provides benefits in that since the bolt 36 is fixed to one of the links, the bolt will not rotate relative to the two links to loosen the joint. Further, the boss-support surface which can be closely machined also ensures the joint is less likely to loosen. Instead, the link will be more reliable than the prior art, and the likelihood of the showerhead moving is dramatically reduced. The bolt may be welded or otherwise fixed, or formed integrally with the cup.

Although a preferred embodiment of this invention has been disclosed, a worker of ordinary skill in the art would recognize that certain modifications would come within the scope of this invention. For that reason, the following claims should be studied to determine the true scope and content of this invention.

1. A mount for a showerhead comprising:
a showerhead having a first link with a fluid passage for receiving water and delivering water to said showerhead;
said first link being connected to a second link at a pivot joint, and said first and second links each being provided with a pivot joint connection portion, with one of said pivot joint connection portions having an end wall and a cup extending from said end wall, and a second of said pivot joint connection portions being a hollow cylindrical member to be received adjacent said cup, with a threaded member being fixed to be immovable relative to said end wall, and extending beyond said sup such that said hollow cylindrical member can be brought adjacent to said cup, with a nut then secured onto said threaded member on an opposed side of said hollow cylindrical member from said cup to secure said first and second links.

2. The mount arrangement as set forth in claim 1, wherein said first link is provided with said end wall, said cup, and said threaded member.

3. The mount system as set forth in claim 1, wherein a wing nut is utilized as said nut.

4. The mount assembly as set forth in claim 1, wherein a seal is placed between said cup and said hollow cylindrical member, and another seal is placed between said hollow cylindrical member said nut.

5. The mount assembly as set forth in claim 1, wherein said second link is pivotally connected to a third link, with a second pivot joint being provided between said second and third links, said second pivot joint also including an end wall and a cup with a fixed threaded member on one of said second and third links, and the other of said second and third links including a hollow cylindrical member to be brought adjacent to said cup, and to receive a nut to secure said cylindrical member to said cup by being tightened on said threaded member.

6. The mount assembly as set forth in claim 1, wherein said cup has a cylindrically extending boss and a ledge, and said hollow cylindrical member has a cylindrically extending boss and a ledge, with said cylindrically extending bosses of said cup and said hollow cylindrical member interfitting to define closely fit, and mutually contacting support surfaces.

7. The mount assembly as set forth in claim 6, wherein said cup has a boss with an outer peripheral surface which supports an inner peripheral surface of said boss of said hollow cylindrical member.

8. The mount assembly as set forth in claim 1, wherein said threaded member has a non-uniform outer periphery, with a smaller portion aligned with the flow passage for passing fluid from said cup into said first link.

9. A mount for a showerhead comprising:
a showerhead having a first link with a fluid passage for receiving water and delivering water to said showerhead;
said first link being connected to a second link at a pivot joint, and said first and second links each being provided with a pivot joint connection portion, with one of said pivot joint connection portions having an end wall and a first cup extending from said end wall, and a second of said pivot joint connection portions being a hollow cylindrical member to be received adjacent said first cup, with a threaded member being immovably fixed to said end wall, and extending beyond said first cup, such that said hollow cylindrical member can be brought adjacent to said first cup, with a nut then secured onto said threaded member on an opposed side of said hollow cylindrical member from said first cup to secure said first and second links;
said second link is pivotally connected to a third link, with a second pivot joint being provided between said second and third links, said second pivot joint also including an end wall and a second cup with a threaded member immovably fixed on one of said second and third links, and another of said second and third links including a hollow cylindrical member to be brought adjacent to said second cup, and to receive a nut to secure said hollow cylindrical member to said second cup by being tightened on said threaded member; and
each of said first and second cups having a cylindrically extending boss and a ledge, and each of said hollow cylindrical members having a cylindrically extending boss and a ledge, with said cylindrically extending bosses of said cups and said hollow cylindrical members interfitting to define closely fit, and mutually contacting support surfaces.

10. The mount arrangement as set forth in claim 9, wherein said first and third links are provided with said end walls, said first and second cups, and said threaded members.

11. The mount assembly as set forth in claim 10, wherein said each of said first and second cups has a boss with an outer peripheral surface with supports and inner peripheral surface of said bosses of said hollow cylindrical members.

12. The mount assembly as set forth in claim 9, wherein said threaded members have a non-uniform outer periphery, with a smaller portion aligned with the flow passages.

13. A pivot connection for a shower comprising:
a pair of links, said links being hollow and allowing passage of water through said links to a showerhead;
one of said links including an end wall, with a cup extending axially from said end wall, and a threaded member immovably fixed to said end wall and extending through and beyond said cup; and
the other of said links including a hollow cylindrical member abutting said cup, with a nut attached to said threaded portion on an opposed side of said hollow cylindrical member from said cup, with said threaded member being immovably fixed to said end wall.

14. The pivot connection as set forth in claim 13, wherein said cup has a cylindrically extending boss and a ledge, and said hollow cylindrical member has a cylindrically extending boss and a ledge, with said cylindrically extending bosses of said cup and said hollow cylindrical member interfitting to define closely fit, and mutually contacting support surfaces.

15. The pivot connection as set forth in claim 14, wherein said cup has a boss with an outer peripheral surface which supports an inner peripheral surface of said boss of said hollow cylindrical portion.

16. The pivot connection as set forth in claim 13, wherein said threaded member has a non-uniform outer periphery, with a smaller portion aligned with a flow passage for passing fluid from said cup into one of said links.
